(19) United States
(12) Patent Application Publication
(10) Pub. No.: US 2015/0193557 A1
(43) Pub. Date: Jul. 9, 2015

(54) DESIGN SUPPORT SYSTEM, DESIGN SUPPORT PROCESSING METHOD, AND DESIGN SUPPORT PROCESSING PROGRAM

(71) Applicant: HITACHI, LTD., Tokyo (JP)

(72) Inventors: Azuma Okuno, Tokyo (JP); Masayuki Hariya, Tokyo (JP); Ichiro Nishigaki, Tokyo (JP); Ichiro Kataoka, Tokyo (JP)

(21) Appl. No.: 14/410,783

(22) PCT Filed: Sep. 24, 2012
(86) PCT No.: PCT/JP2012/074449

§ 371 Date: Dec. 23, 2014

(51) Int. Cl. G06F 17/50

(52) U.S. Cl. CPC G06F 17/50

(57) ABSTRACT

The present invention provides a design support system for easily identifying extent of impact of design change while saving the labor involved in working on the design change. The system includes: a simulation execution unit that executes a simulation by executing a program on a server using predetermined parameters regarding the design of an object; an extent-of-impact extraction unit that extracts extent of impact that parts are subject to due to design change, from an analysis result obtained through execution of the simulation by the simulation execution unit; and an output unit that outputs the extent of impact extracted by the extent-of-impact extraction unit.

### TECHNICAL FIELD

The present invention relates to a design support system, a design support processing method, and a design support processing program. More particularly, the invention relates to design support techniques for analyzing design data by use of a computer, such as a server, so as to extract the extent of impact of design change in product design.

### BACKGROUND ART

Design support techniques have been in practical use for automatically designing device products or the like through CAD (Computer Aided Design). It may well happen that a product designed through CAD needs to undergo design change in response to the customer's request or due to the environment in which the product is to be used. Where the existing product is to be changed in design, it is necessary to identify the range of product parts impacted by the changed specifications and evaluate the impact of the change. For that reason, study has been underway on design support systems that facilitate grasping of the objects to be verified at the time of design change.

With regard to the verification of design change, Patent Document 1, for example, discloses a design support system including extracted node presenting means that creates a functional model for hierarchically defining a interrelation between the functions to be performed by a design target device and the parts for implementing the functions, identifies from the functional model the extent of impact at the time of design change, and presents a user with what was identified.

### PRIOR ART LITERATURE

### Patent Document

Patent Document 1: JP-2005-322211-A

### SUMMARY OF THE INVENTION

### Problem to be Solved by the Invention

According to the technique disclosed in Patent Document 1, the user is involved in creating the functional model, which requires many man-hours. Other problems are that an impact taking place but inconceivable in view of the existing design knowledge may be overlooked and that the accuracy of the functional model depends on the knowledge of the user who created it.

An object of the present invention is to provide a design support system, a design support processing method, and a design support processing program for easily identifying the extent of impact of design change while saving the labor involved in working on the design change.

### Means for Solving the Problem

The design support system according to the present invention is preferably a design support system for supporting design change of an object by use of a server. The design support system includes: a simulation execution unit that executes a simulation by executing a program on the server using a predetermined parameter regarding a design of the object; an extent-of-impact extraction unit that extracts extent of impact that parts are subject to due to design change, from an analysis result obtained through execution of the simulation by the simulation execution unit; and an output unit that outputs the extent of impact extracted by the extent-of-impact extraction unit.

Preferably in the design support system, the simulation execution unit executes an analysis program to obtain the analysis result made of specific numerical data corresponding to the parameters regarding each of the parts constituting the object. The design support system further includes an extent-of-impact database creation unit that uses an impact evaluation function, input through input means, to calculate degree of impact of a changed part with respect to the analysis result data, in order to create an extent-of-impact database. The extent-of-impact extraction unit extracts the extent of impact from the extent-of-impact database created by the extent-of-impact database creation unit.

Preferably, the design support system may further include: a configuration data creation unit that creates standard design CAD configuration data and design change CAD configuration data in a text file format from standard design CAD data and design change CAD data at a time of design change; and a configuration data difference extraction unit that extracts a difference between the standard design CAD configuration data and the design change CAD configuration data both created by the configuration data creation unit. The extent-of-impact extraction unit searches through the extent-of-impact database to extract parts impacted at the time of design change from among parts which are subject to design change, the latter parts having had a difference thereof extracted by the configuration data difference extraction unit.

Preferably in the design support system, by use of the impact evaluation function input from the input means, the extent-of-impact extraction unit searches through extent-of-impact database to extract parts of which the impact evaluation function have a value exceeding an impact evaluation function threshold value. The parts are extracted from among parts which are subject to design change and of which the differences have been extracted by the configuration data difference extraction unit.

The design support processing method according to the present invention is preferably a design support processing method for supporting design change of an object by use of a server. The design support processing method includes: a simulation execution step for executing a simulation, by executing a program on the server, using predetermined parameters regarding design of the object; an extent-of-impact extraction step for extracting extent of impact that parts are subject to due to design change, from an analysis result obtained through execution of the simulation in the simulation execution step; and an output step for outputting the extent of impact extracted by the extent-of-impact extraction unit.

The design support processing program according to the present invention is preferably a design support processing program for supporting design change of an object by use of a server. The design support processing program includes: a simulation execution step for executing a simulation using predetermined parameters regarding the design of the object; an extent-of-impact extraction step for extracting extent of impact that parts are subject to due to design change, from an analysis result obtained through execution of the simulation in the simulation execution step; and an output step for outputting the extent of impact extracted by the extent-of-impact extraction unit.

### Effect of the Invention

The present invention makes it easy to identify the extent of impact of design change while saving the labor involved in working on the design change.

### BRIEF DESCRIPTION OF THE DRAWINGS

FIG. 1 is a diagram showing a configuration of a design support system as one embodiment of the present invention.

FIG. 2 is a flowchart showing the processing operation of an automatic simulation execution unit.

FIG. 3 is a diagram showing an example of a display screen used for inputting shape data and for creating configuration data.

FIG. 4 is a diagram showing an example of configuration data.

FIG. 5 is a diagram showing an example of a screen display used for executing a simulation.

FIG. 6 is a diagram showing an example of a structure of an analysis result database.

FIG. 7 is a diagram showing an example of a display screen used for creating an extent-of-impact database.

FIG. 8 is a flowchart showing the processing operation for creating the extent-of-impact database.

FIG. 9 is a diagram showing an example of extent-of-impact database.

FIG. 10 is a flowchart showing the processing operation carried out at the time of design change.

FIG. 11 is a diagram showing an example of screen for extracting and displaying the extent of impact at the time of design change.

### MODE FOR CARRYING OUT THE INVENTION

One embodiment of the present invention will be explained below with reference to the accompanying drawings.

### First Embodiment

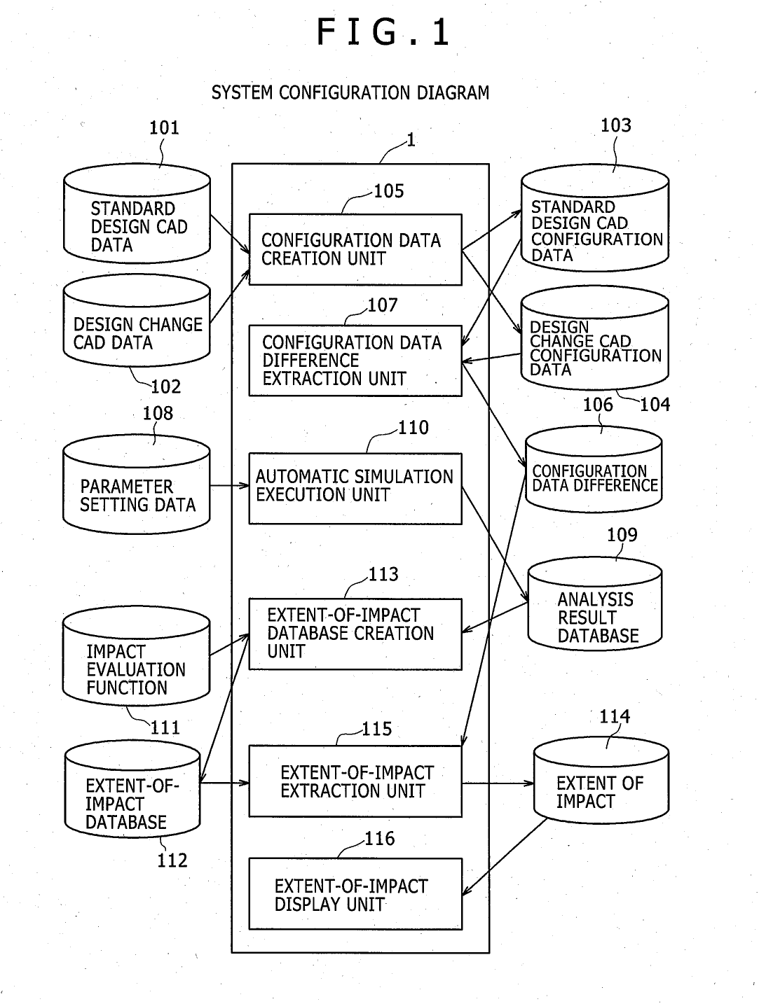

FIG. 1 shows an example of configuration of a design support system as one embodiment of the present invention. The design support system includes a server 1 that performs design support work and a database (DB) that stores related data. The hardware structure, not shown, of the server 1 is made up of a processor (CPU) that executes programs, a memory that stores the programs and various data, an input device for inputting data, and a display device for outputting data. The database is created in a mass storage device such as a hard disk.

The execution on the server 1 of a program specific to this embodiment generates a design support system having the functions described below. That is, the design support system is configured to have a configuration data creation unit 105 that creates standard design CAD configuration data 103 and three-dimensional design change CAD configuration data 104 by use of standard design CAD data 101 and design change CAD 102; a configuration data difference extraction unit 107 that creates configuration data differences 106 using the standard design CAD configuration data 103 and the design change CAD configuration data 104; an automatic simulation execution unit 110 that creates a standard analysis model from parameter setting data 108, performs analysis with the created analysis model, and outputs an analysis result database 110; an extent-of-impact database creation unit 113 that creates an extent-of-impact database 112 by use of the analysis result database 109 and a user-input impact evaluation function 111; an extent-of-impact extraction unit 115 that extracts an extent of impact 114 upon design change by use of the extent-of-impact database 113 and the configuration data differences 106 created at the time of design change; and an extent-of-impact display unit 116 that outputs and displays the extent of impact 114 for the user.

The standard design CAD data here refer to standard CAD data prepared in advance as a basis for changing the design due to the customer's request or of the specification environment. The design change CAD data 102 refer to CAD data derived from the standard design CAD data 101 that have been subject to design change.

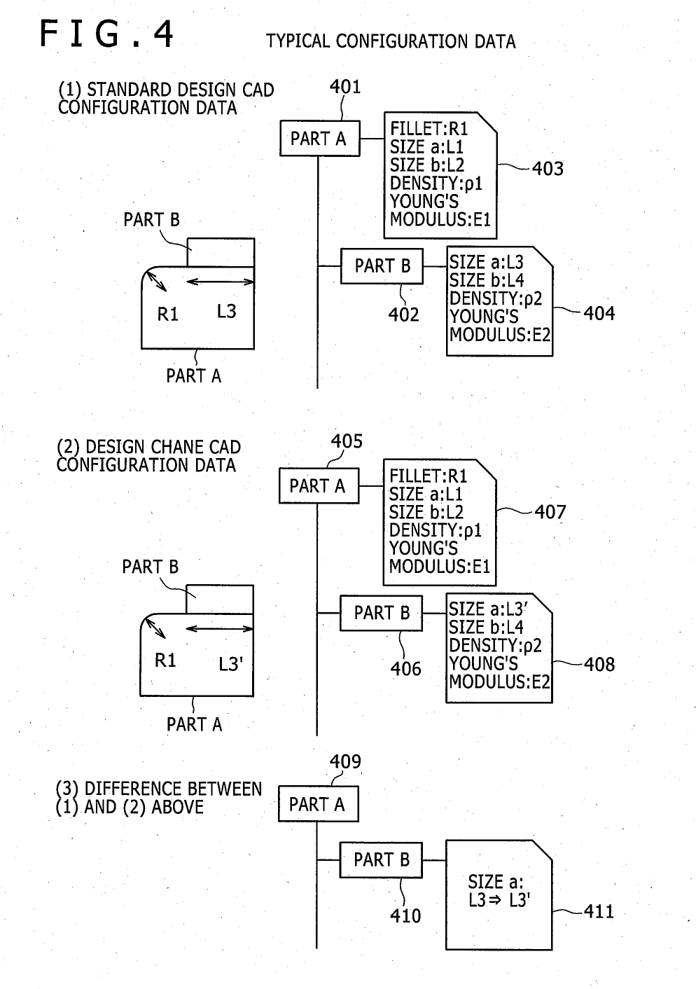

Moreover, the standard design CAD configuration data 103 and the design change CAD configuration data 104 refer to the data created in a text file format by extracting, from the standard design CAD data 101 and the design change CAD data 102, the parameters that may be varied at the time of design change such as part names, feature names, surface types, sizes, and materials. More specifically, as shown in FIG. 4, the configuration data are made up of the CAD data on the subordinate relations between hierarchically configured parts as indicated by reference numerals 401 and 402. Each of the parts is accompanied by attribute data including physical properties such as the sizes of a fillet and edges constituting the parts as well as the density and Young's modulus of the material of the part, as indicated in reference numerals 403 and 404.

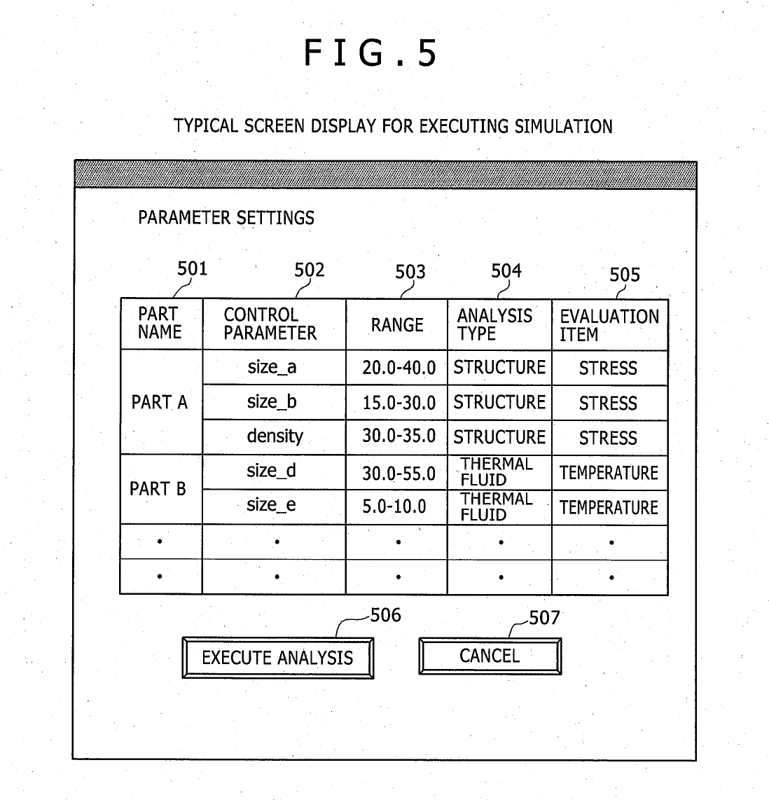

The parameter setting data represent, as shown in FIG. 5, part names 501, control parameters 502 such as sizes and physical properties attributed to each part, variation ranges 503 of the parameters, analysis types 504, and analysis result evaluation items 505. These data are input through the screen.

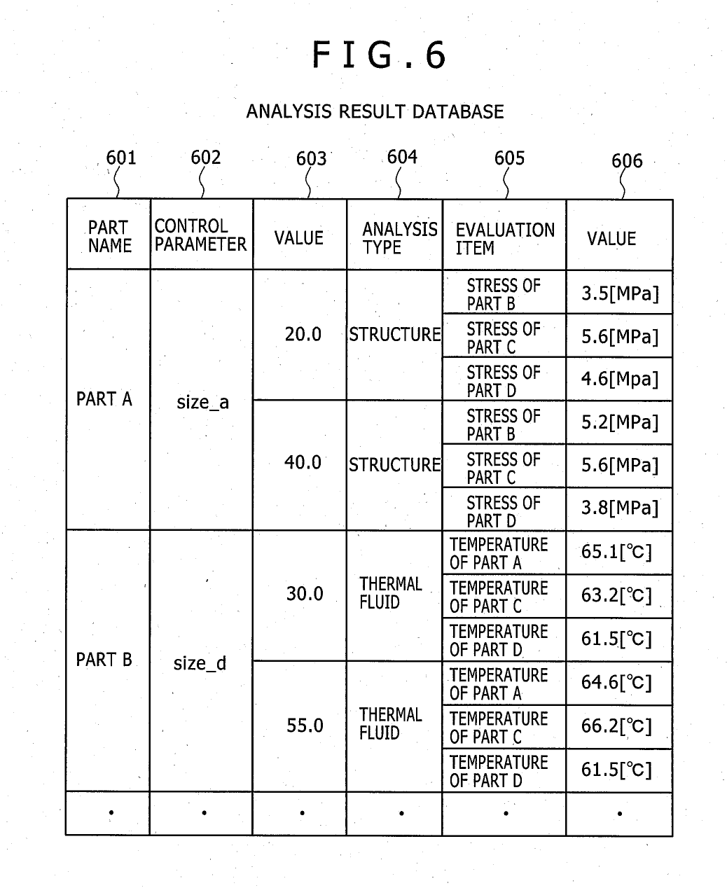

As shown in FIG. 6, the analysis result database 109 is made up of entries including part names 601, control parameters 602, control parameter values 603, analysis types 604, evaluation items 605, and evaluation item values 606 calculated through analyses, the entries corresponding to the parameter setting, data indicated in FIG. 5.

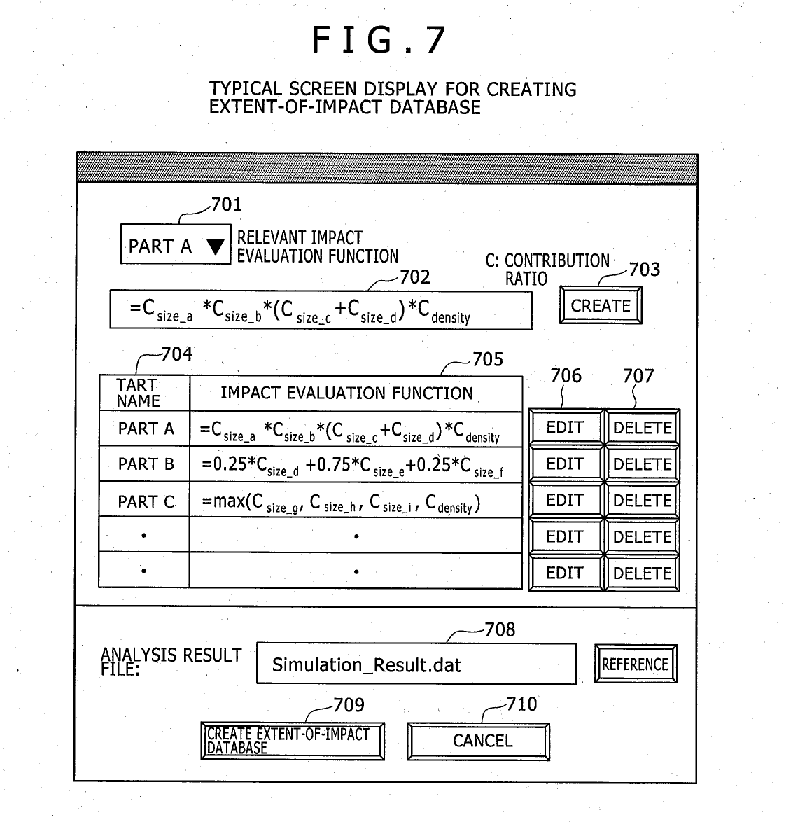

Moreover, as shown in FIG. 7, the impact evaluation function is a function for evaluating the degree of impact of each applicable part as a whole, by use of a contribution ratio of each of the parameters calculated from the result of the simulation. The larger the value of the function is, the higher the degree of impact is. This function is evaluated depending on the parameter types of the parts involved and on the analyses to be carried out. The contribution ratio is a quantitative index that indicates to what extent the variations of objective functions (evaluation item values 606 in this case) are impacted by design variables (control parameter values 603 in this case). For example, the contribution ratio may be calculated by use of such techniques as analysis of variance and sensitivity analysis.

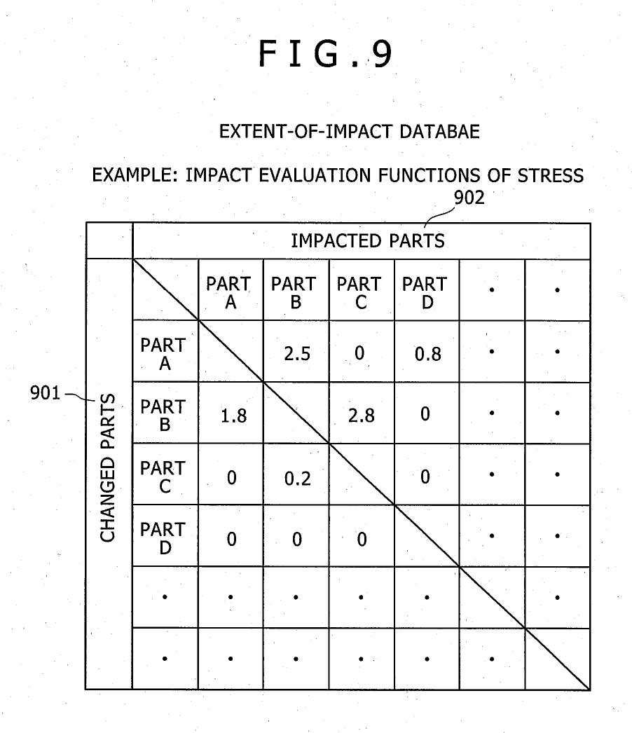

As shown in FIG. 9, the extent-of-impact database 112 is made up of the result of the impact evaluation function calculated for each analysis type from the contribution ratios. These contribution ratios were previously calculated from the analysis result database 109 with regard to the evaluation items of the other parts (impacted parts 902) when the control parameters of a given part (changed part 901) are changed. The extent-of-impact database 112 is presented in a tabular form as illustrated. FIG. 9 shows an example of impact evaluation function of stress.

Searching through the extent-of-impact database 112 provides a search for the entire extent of impact as a result of design change.

The present invention thus saves labor by using the automatic simulation execution unit 110 and extent-of-impact database creation unit 113 to automatically create the extent-of-impact database 112 that used to be created manually by the user, and by having the extent-of-impact extraction unit 115 extract the extent of impact at the time of design change.

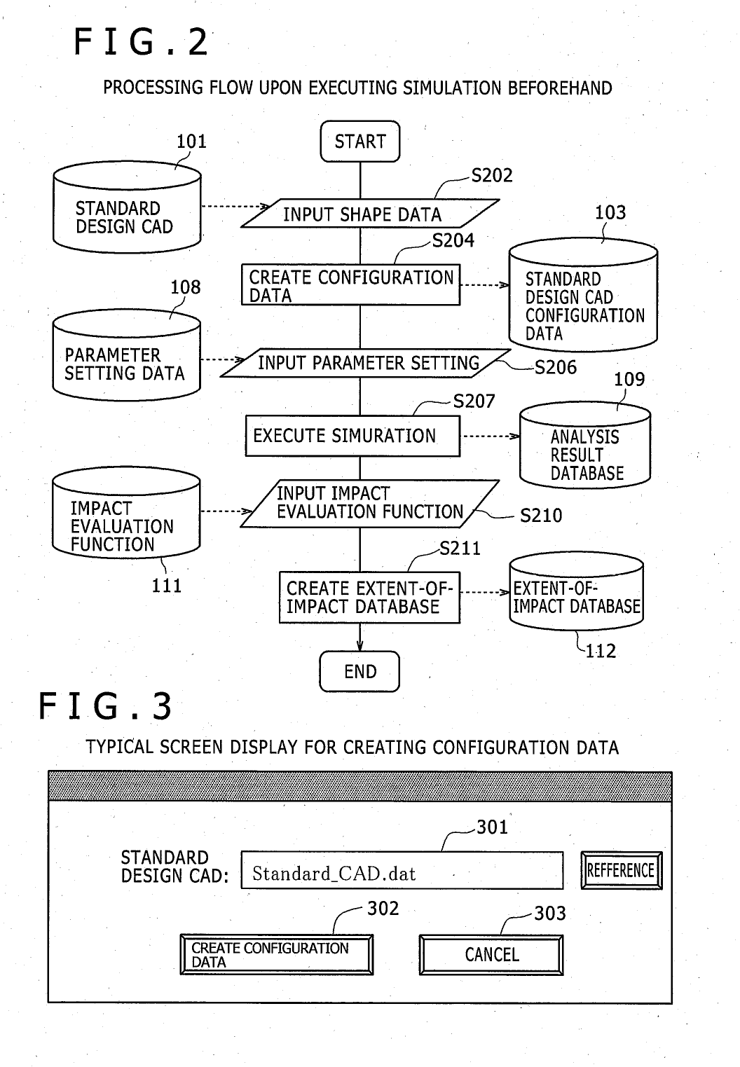

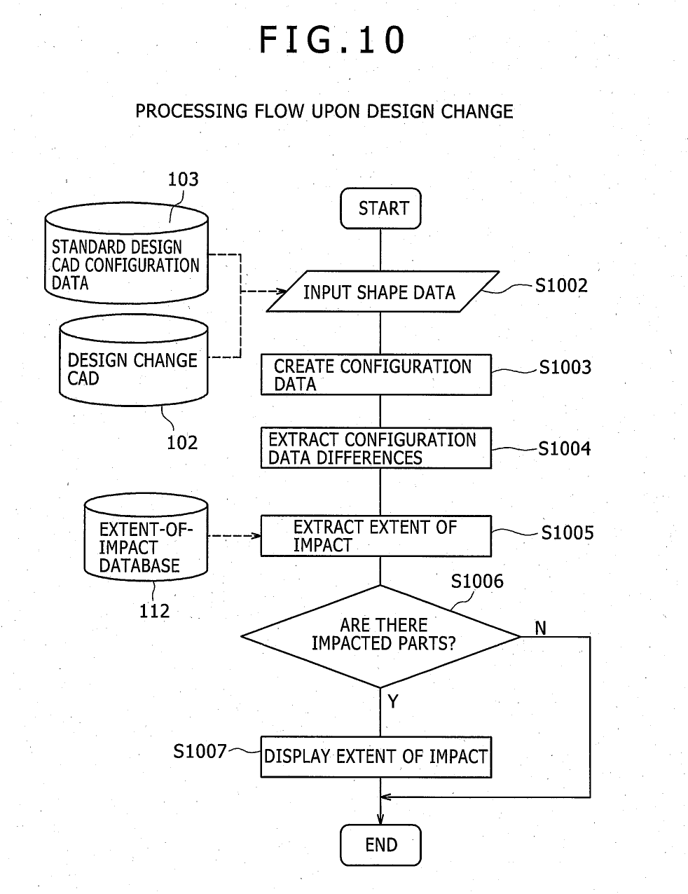

The steps of the processing performed by the design support system of this embodiment may be divided into the first half of steps (see FIG. 2) in which simulations are repeatedly executed beforehand to create the extent-of-impact database 112 and the latter half of steps (see FIG. 10) in which changes are extracted at the time of design change and the extent of impact thereby is identified. The process of each of the steps will be explained below.

The processing operation of simulation execution will now be explained with reference to FIG. 2. In FIG. 2, the processes indicated by rectangular frames (S204, S207, S211) represent those executed automatically by the server 1. The processes indicated by parallelogram frames represent those operated and executed interactively by the user with input and display devices. The solid lines denote the flow of processes, and the dotted lines represent the flow of data.

First, the user inputs shape data as the standard design CAD data 101 (S202) by use of the input and display devices. The configuration data creation unit 105 creates the standard design CAD configuration data 103 in a text file format by use of the input shape data (S204). The creation of the configuration data will be discussed later with reference to FIG. 3.

The user then inputs the parameter setting data 108 by use of the input and display devices (S206). The input of the parameter setting data 108 will be discussed later with reference to FIG. 5.

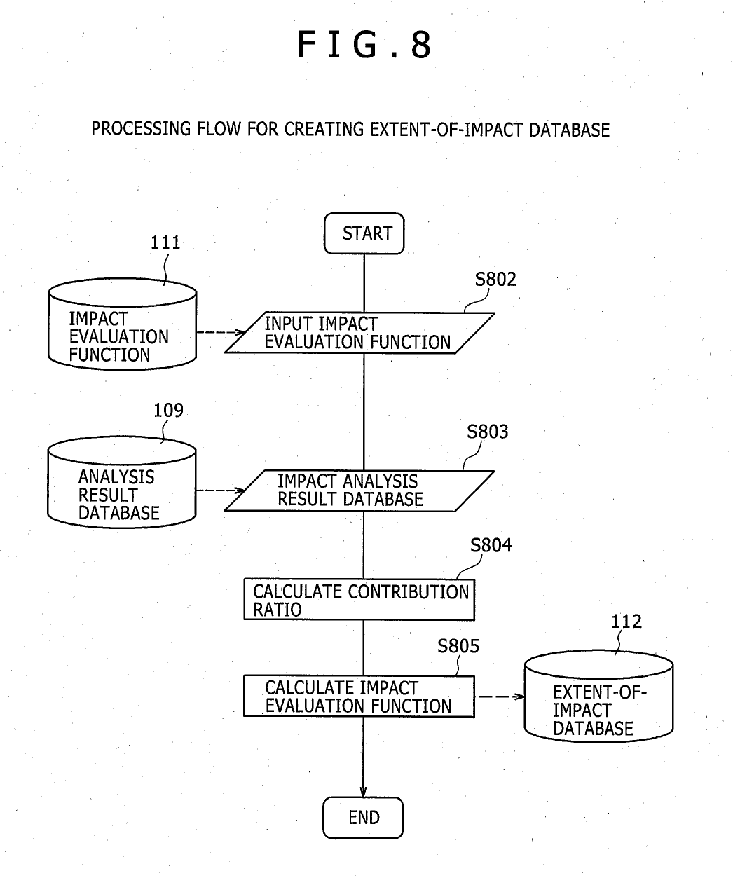

With the parameter setting data input, the automatic simulation execution unit 110 creates an analysis model from the parameter setting data 108, performs a simulation with the analysis model (S207), and outputs the result of the simulation execution to the analysis result database 109. Thereafter, the user inputs the impact evaluation function 111 (to be discussed later with reference to FIG. 7) by use of the input and display devices (S210). In turn, the extent-of-impact database creation unit 113 creates the extent-of-impact database 112 (S211). The processing by the extent-of-impact database creation unit and the structure of the extent-of-impact database will be discussed later with reference to FIGS. 8 and 9.

FIG. 3 shows an example of a display screen used for inputting shape data (S202) and for creating configuration data (S204) with the configuration data creation unit 105. The user specifies standard design CAD data in an item field 301 on the display screen of the display device, and operates a configuration data creation button 302. This operation causes the configuration data creation unit 105 to create configuration data. The configuration data thus created constitute the CAD data. The subordinate relations between the parts of CAD data are shown in a hierarchical manner as in FIG. 4 (401, 402). The respective parts are accompanied by attribute data including physical properties such as the sizes of a fillet and edges constituting the part as well as the density and Young's modulus of the material of the part as indicated by reference numerals 403 and 404.

FIG. 5 shows an example of a display screen used for processing with the automatic simulation execution unit 110. In a parameter setting input step S206, the user makes entries into the fields of part names 501, control parameters 502 such as the sizes and physical properties of the parts of interest, variation ranges 503 of the parameters, analysis types 504, and analysis result evaluation items 505 on the display screen appearing on the display device. With these item data input, operating an analysis execution button 506 causes the automatic simulation execution unit 110 to execute analyses repeatedly while automatically changing the designated parameters within their variation ranges, before outputting the analysis result database 208.

Specifically, the changed parameters are output in the form of an input file to the analysis program, so that the automatic simulation execution unit 110 executes the analysis program (mesh generation, analysis solver, result processing). Here, the parameter setting data 108 refer to the data representing the entries in the fields 501 to 505 in FIG. 5 in a text file format or the like. As a result of execution of the analysis program, the data representing the items in the analysis result database 109 shown in FIG. 6 for example are obtained, the data corresponding to the parameter setting data indicated in FIG. 5.

Explained next with reference to FIG. 7 is an example of a display screen for use with the extent-of-impact database creation unit 113 along with the processing operation performed thereby.

On the display screen appearing on the display device, the user selects target parts from an item 701, inputs the impact evaluation functions of the target parts to an item 702, and operates a create button 703. This operation causes the impact evaluation functions to be added to the listed fields of part names 704 and impact evaluation functions 705. The impact evaluation function is a function for evaluating the degree of impact of each applicable part as a whole by use of the contribution ratio of each of the parameters calculated from the result of the simulation. The contribution ratio is a quantitative index that indicates to what extent the variations of objective functions (evaluation item values 606 in this case) are impacted by the design variables (control parameter values 603 in this case).

Because the impact evaluation function is an index indicative of the degree of, impact of a given changed part on the other parts, if the model is made up of as many as M parts, then M²-M values are calculated for each analysis type. Furthermore, the user may edit or delete the created impact evaluation functions by operating an edit button 706 or a delete button 707. Here, a previously created analysis result file 208 is read through an analysis result database input unit 708, and a button 709 is operated to create the extent-of-impact database 212. In the manner described above, the degree of impact that a given changed part could have on the other parts can be expressed numerically on a one-to-one basis by use of the impact evaluation function obtained from the contribution ratios of multiple control functions.

The processing operation of the extent-of-impact database creation unit will be explained next with reference to FIG. 8. In an impact evaluation function input step S802, the impact evaluation function 111 is read. In an analysis result database input step S803, the analysis result database 109 is read.

In a contribution ratio calculation step S804, the contribution ratio is calculated by use of the data from the analysis result database 109. Then, in an impact evaluation function calculation step S805, the impact evaluation function is calculated from the calculated contribution ratio and is output to the extent-of-impact database 112. Searching through the extent-of-impact database 112 provides a search for the entire extent of impact without omission at the time of design change.

The processing operation performed at the time of design change will be explained next with reference to FIG. 10.

First in a shape data input step S1002, the user inputs the standard design CAD configuration data 103 and design change CAD data 102 by use of the input and display devices. In turn, the configuration data creation unit 105 creates configuration data regarding the design change CAD data 102 (S1003). As shown in portion (2) of FIG. 4, the design change CAD configuration data 104 have the same structure as the standard design CAD configuration data; the parameter changed in design (size a of part B in FIG. 4) has a different value. As indicated in FIGS. 3 and 4, the process for creating the configuration data from the design change CAD data 102 is the same as the process for creating the configuration data from the standard design CAD.

Then in a configuration data difference extraction step S1004, the configuration data difference extraction unit 107 extracts configuration data differences between the standard design CAD configuration data 103 and the design change CAD data 102. As shown in portion (3) of FIG. 4, the configuration data differences constitute the data representing the differences between the standard design CAD configuration data and the design change CAD configuration data. The configuration data differences are created in the form of a configuration data difference file that is output following a search for the differences between the standard design CAD configuration data 103 and the design change CAD configuration data 104.

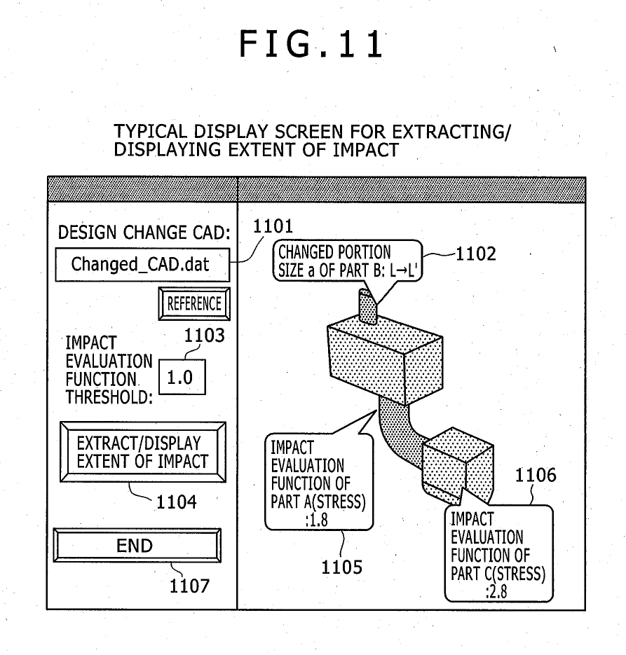

Later in an extent-of-impact extraction step S1005, the extent-of-impact extraction unit 115 extracts the extent of impact following input of the data from the extent-of-impact database 112 and the configuration data differences 106. As shown in FIG. 11, the process of extent-of-impact extraction is carried out by searching the extent-of-impact database in FIG. 9 for the impact evaluation functions exceeding a user-input impact evaluation function threshold value. At this point, it is determined whether there are any impacted parts (S1006). If impacted parts are determined to exist, the extent-of-impact display unit 116 causes the extent of impact to be output to and displayed on the display device as items to be evaluated by the user.

Explained below with reference to FIG. 11 is how the extent of impact is extracted at the time of design change, along with how an example of a display screen is shown. The user inputs design change CAD data to an item 1101. In turn, the configuration data difference extraction unit 107 compares the design change CAD data with the standard design CAD configuration data. As a result of the comparison, the changed portion is shown highlighted on the display screen as indicated by reference numeral 1102. The user then inputs an impact evaluation function threshold value to an item 1103, and operates an extent-of-impact extraction/display button 1104. This operation causes the extent-of-impact extraction unit 115 to search the changed parts through the extent-of-impact database so as to extract the parts having values exceeding the impact evaluation function threshold value. As a result, the applicable part names, analysis types, and impact evaluation functions are shown highlighted on the display screen as indicated by reference numerals 1105 and 1106.

As described above, in case there is any design change, the change is extracted as configuration data differences. The previously created extent-of-impact database is referenced for the parts of which the impact evaluation functions are different. The parts with their values exceeding the user-input threshold value are then extracted as the parts impacted by the design change and can be displayed as such on the display screen. Furthermore, when impacted parts are to be changed, all the parts impacted by the design change are extracted and displayed on the screen, so that the user can evaluate the entire extent of impact of the design change.

According to the above-described embodiment of the present invention, it is easy to identify the extent of impact of design change while saving the labor involved in working on the design change. That is, simulations are performed repeatedly and automatically beforehand in order to summarize the mutual impact between parts using contribution ratios and evaluation functions, whereby the extent of impact can be identified when the parameters of any part are changed.

This identification allows the user, even a novice in product design, to obtain results equivalent to those of experts with a minimum of workload. In addition, when three-dimensional configuration data are created from CAD data, it is possible to acquire difference data on the design change by use of only a small quantity of data.

### DESCRIPTION OF REFERENCE NUMERALS

1 Server
101 Standard Design CAD
102 Design change CAD
103 Standard design CAD configuration data
104 Design change CAD configuration data database
105 Data creation unit
106 Configuration data difference database
107 Configuration data difference extraction unit
108 Parameter setting data database
109 Analysis result database
110 Automatic simulation execution unit
111 Impact evaluation function database
112 Extent-of-impact database
113 Extent-of-impact database creation unit
114 Extent-of-impact database
115 Extent-of-impact extraction unit
116 Extent-of-impact display unit

1. A design support system for supporting design change of an object by use of a server, the design support system comprising:
a simulation execution unit that executes a simulation by executing a program on the server using a predetermined parameter regarding a design of the object;
an extent-of-impact extraction unit that extracts extent of impact that parts are subject to due to design change, from an analysis result obtained through execution of the simulation by the simulation execution unit; and
an output unit that outputs the extent of impact extracted by the extent-of-impact extraction unit.

2. The design support system according to claim 1,
wherein the simulation execution unit obtains the analysis result by executing the simulation using names of parts; control parameters such as sizes and physical properties of the parts; and variation ranges, analysis types, and analysis result evaluation items of the control parameters, and
wherein the analysis result, including the names of the parts corresponding to the parameters, obtained values of the parameters, analysis types, evaluation items, and evaluation item values calculated through analysis, is obtained, the analysis result being further stored into a analysis result database,
the design support system further comprising an extent-of-impact database creation unit that uses an impact evaluation function, input through input means, to calculate degree of impact of a changed part with respect to the analysis result data, in order to create an extent-of-impact database,
wherein the extent-of-impact extraction unit searches through the extent-of-impact database created by the extent-of-impact database creation unit to extract the extent of impact of parts of the impact evaluation function from the extent-of-impact database, the parts having the impact evaluation function with a value exceeding an impact evaluation function threshold value.

3. The design support system according to claim 1, further comprising:
a configuration data creation unit that creates standard design CAD configuration data and design change CAD configuration data in a text file format from standard design CAD data and design change CAD data at a time of design change; and
a configuration data difference extraction unit that extracts a difference between the standard design CAD configuration data and the design change CAD configuration data both created by the configuration data creation unit,
wherein contribution ratios are used to represent quantitatively to what extent variations in values of the evaluation items (objective functions) are impacted by values of the control parameters (design variables),
wherein the impact evaluation function is a function that evaluates degree of impact of each part as a whole by use of the contribution ratios of the parameters calculated from a result of the simulation executed by the simulation execution unit, and
wherein the extent-of-impact extraction unit uses the impact evaluation function to search through extent-of-impact database for sake of extraction.

4. The design support system according to claim 3,
wherein, by use of the impact evaluation function input from the input means, the extent-of-impact extraction unit searches through extent-of-impact database to extract parts of which the impact evaluation function have a value exceeding an impact evaluation function threshold value,
wherein the parts are extracted from among parts which are subject to design change and of which the differences have been extracted by the configuration data difference extraction unit, and
wherein the extent-of-impact extraction unit then outputs the extracted extent of impact to the output unit.

5.-7. (canceled)

8. A design support processing method for supporting design change of an object by use of a server, the design support processing method comprising:
a simulation execution step for executing a simulation, by executing a program on the server, using predetermined parameters regarding design of the object;
an extent-of-impact extraction step for extracting extent of impact that parts are subject to due to design change, from an analysis result obtained through execution of the simulation in the simulation execution step; and
an output step for outputting the extent of impact extracted by the extent-of-impact extraction unit.

9. The design support processing method according to claim 8,
wherein the simulation execution step is for obtaining the analysis result by executing the simulation using names of parts; control parameters such as sizes and physical properties of the parts; and variation ranges, analysis types, and analysis result evaluation items of the control parameters, and
wherein the analysis result, including the names of the parts corresponding to the parameters, obtained values of the parameters, analysis types, evaluation items, and evaluation item values calculated through analysis, is obtained, the analysis result being further stored into an analysis result database,
the design support system further comprising an extent-of-impact database creation unit that uses an impact evaluation function, input through input means, to calculate degree of impact of a changed part with respect to the analysis result data,
wherein the extent-of-impact extraction step is for searching through the created extent-of-impact database to extract the extent of impact of parts of the impact evaluation function from the extent-of-impact database, the parts having the impact evaluation function with a value exceeding an impact evaluation function threshold value.

10. The design support processing method according to claim 8, further comprising:
a configuration data creation step for creating standard design CAD configuration data and design change CAD configuration data in a text file format from standard design CAD data and design change CAD data at a time of design change; and
a configuration data difference extraction step for extracting a difference between the standard design CAD configuration data and the design change CAD configuration data created in the configuration data creation step,
wherein contribution ratios are used to represent quantitatively to what extent variations in values of the evaluation items (objective functions) are impacted by values of the control parameters (design variables),
wherein the impact evaluation function is a function that evaluates degree of impact of each part as a whole by use of the contribution ratios of the parameters calculated from a result of the simulation executed by the simulation execution unit, and
wherein the extent-of-impact extraction step is for searching through the extent-of-impact database to extract the parts to be impacted at the time of design change from among the parts which are subject to design change and of which the differences have been extracted in the configuration data difference extraction step, the extent-of-impact extraction step including the output step for outputting the extracted extent of impact.

11. A design support processing program for supporting design change of an object by use of a server, the design support processing program comprising:
a simulation execution step for executing a simulation using predetermined parameters regarding the design of the object;
an extent-of-impact extraction step for extracting extent of impact that parts are subject to due to design change, from an analysis result obtained through execution of the simulation in the simulation execution step; and
an output step for outputting the extent of impact extracted by the extent-of-impact extraction unit.

12. The design support system according to claim 2, further comprising:
a configuration data creation unit that creates standard design CAD configuration data and design change CAD configuration data in a text file format from standard design CAD data and design change CAD data at a time of design change; and
a configuration data difference extraction unit that extracts a difference between the standard design CAD configuration data and the design change CAD configuration data both created by the configuration data creation unit,
wherein contribution ratios are used to represent quantitatively to what extent variations in values of the evaluation items (objective functions) are impacted by values of the control parameters (design variables),
wherein the impact evaluation function is a function that evaluates degree of impact of each part as a whole by use of the contribution ratios of the parameters calculated from a result of the simulation executed by the simulation execution unit, and
wherein the extent-of-impact extraction unit uses the impact evaluation function to search through extent-of-impact database for sake of extraction.

13. The design support processing method according to claim 9, further comprising:
a configuration data creation step for creating standard design CAD configuration data and design change CAD configuration data in a text file format from standard design CAD data and design change CAD data at a time of design change; and
a configuration data difference extraction step for extracting a difference between the standard design CAD configuration data and the design change CAD configuration data created in the configuration data creation step,
wherein contribution ratios are used to represent quantitatively to what extent variations in values of the evaluation items (objective functions) are impacted by values of the control parameters (design variables),
wherein the impact evaluation function is a function that evaluates degree of impact of each part as a whole by use of the contribution ratios of the parameters calculated from a result of the simulation executed by the simulation execution unit, and
wherein the extent-of-impact extraction step is for searching through the extent-of-impact database to extract the parts to be impacted at the time of design change from among the parts which are subject to design change and of which the differences have been extracted in the configuration data difference extraction step, the extent-of-impact extraction step including the output step for outputting the extracted extent of impact.
